(19) United States
(12) Patent Application Publication
(10) Pub. No.: US 2022/0122778 A1
(43) Pub. Date: Apr. 21, 2022

(54) ELECTRONIC MODULATING DEVICE INCLUDING DIFFERENT CELL GAPS

(71) Applicant: InnoLux Corporation, Miao-Li County (TW)

(72) Inventors: Tang-Chin HUNG, Miao-Li County (TW); Chih-Chiang HSIA, Miao-Li County (TW)

(21) Appl. No.: 17/560,510

(22) Filed: Dec. 23, 2021

Related U.S. Application Data
(62) Division of application No. 16/382,492, filed on Apr. 12, 2019.
(60) Provisional application No. 62/668,883, filed on May 9, 2018.

(30) Foreign Application Priority Data
Nov. 19, 2018 (CN) 201811378673.5

(51) Int. Cl. H01G 7/00; H01G 2/00

(52) U.S. Cl. CPC H01G 7/00; H01G 2/00

(57) ABSTRACT

An electronic modulating device is provided. The electronic modulating device includes a first substrate, a second substrate, at least one working unit and at least one adjustment structure. The second substrate is disposed opposite to the first substrate. The at least one working unit includes a first cell gap and is disposed between the first substrate and the second substrate. The at least one working unit includes a modulating material. The at least one adjustment structure includes a second cell gap and is disposed between the first substrate and the second substrate. The second cell gap is greater than the first cell gap.

### CROSS REFERENCE TO RELATED APPLICATIONS

This application is a Divisional of pending U.S. patent application Ser. No. 16/382,492, filed Apr. 12, 2019, which claims priority of U.S. Provisional Patent Application No. 62/668,883, filed on May 9, 2018 and Chinese Patent Application No. 201811378673.5, filed on Nov. 19, 2018, the entirety of which are incorporated by reference herein.

### BACKGROUND

### Technical Field

The present disclosure relates to an electronic modulating device, and in particular it relates to an electronic modulating device comprising different cell gaps.

### Description of the Related Art

Electronic products that include a display panel, such as smartphones, tablets, notebook computers, monitors, and TVs, have become indispensable necessities in modern society. With the flourishing development of such portable electronic products, consumers have high expectations regarding their quality, functionality, and price. Some of these electronic products may also serve as electronic modulating devices, for example, may be used to modulate electromagnetic waves.

However, the development of an electronic modulating device that can be applied to various environments is still one of the topics that are being researched in the industry currently.

### SUMMARY

In accordance with some embodiments of the present disclosure, an electronic modulating device is provided. The electronic modulating device includes a first substrate, a second substrate, at least one working unit and at least one adjustment structure. The second substrate is disposed opposite to the first substrate. The at least one working unit includes a first cell gap and is disposed between the first substrate and the second substrate. The at least one working unit includes a modulating material. The at least one adjustment structure includes a second cell gap and is disposed between the first substrate and the second substrate. The second cell gap is greater than the first cell gap.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1 is a cross-sectional diagram of an electronic modulating device in accordance with some embodiments of the present disclosure.

FIG. 2 is a cross-sectional diagram of an electronic modulating device in accordance with some embodiments of the present disclosure.

FIG. 3 is a cross-sectional diagram of an electronic modulating device in accordance with some embodiments of the present disclosure.

FIG. 4 is a cross-sectional diagram of an electronic modulating device in accordance with some embodiments of the present disclosure.

FIGS. 5A-5C are top-view diagrams of the electronic modulating devices in accordance with some embodiments of the present disclosure.

### DETAILED DESCRIPTION

The electronic modulating device of the present disclosure and the method for manufacturing the electronic modulating device are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the concept of the present disclosure may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. In addition, the expressions “a layer overlying another layer”, “a layer is disposed above another layer”, “a layer is disposed on another layer” and “a layer is disposed over another layer” may indicate that the layer is in direct contact with the other layer, or that the layer is not in direct contact with the other layer, there being one or more intermediate layers disposed between the layer and the other layer.

It should be noted that the elements or devices in the drawings of the present disclosure may be present in any form or configuration known to those with ordinary skill in the art. In addition, in this specification, relative expressions are used. For example, “lower”, “bottom”, “higher” or “top” are used to describe the position of one element relative to another. It should be appreciated that if a device is flipped upside down, an element that is “lower” will become an element that is “higher”. It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section discussed below could be termed a second element, component, region, layer, portion or section without departing from the teachings of the present disclosure.

The terms “about” and “substantially” typically mean +/−10% of the stated value, more typically mean +/−5% of the stated value, more typically +/−3% of the stated value, more typically +/−2% of the stated value, more typically +/−1% of the stated value and even more typically +/−0.5% of the stated value. The stated value of the present disclosure is an approximate value. When there is no specific description, the stated value includes the meaning of “about” or “substantially”. In addition, the term “be maintained” may refer to +/−15% of the stated value, or +/−10% of the stated value, or +/−5% of the stated value.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

In addition, the phrase “ranged from a first value to a second value” or “in a range between a first value and a second value” indicates that the range includes the first value, the second value, and other values between them.

In accordance with some embodiments of the present disclosure, an electronic modulating device is provided. The electronic modulating device may have different cell gaps, and the adjustment structure may adjust the modulating material (e.g., including liquid-crystal molecules, but not limited thereto) in the working region of the electronic modulating device when the temperature is changed. The working unit of the electronic modulating device may thereby maintain the cell gap. Therefore, the stability of the electronic modulating device may be improved. In addition, in accordance with some embodiments of the present disclosure, compared with the cell gap of the working unit, the adjustment structure may have a greater cell gap. The modulating materials would tend to move toward the cell gap with a smaller cell gap due to the capillary phenomenon. In this way, even if the amount of the modulating material is reduced, the working unit of the electronic modulating device may still include sufficient modulating materials to operate normally.

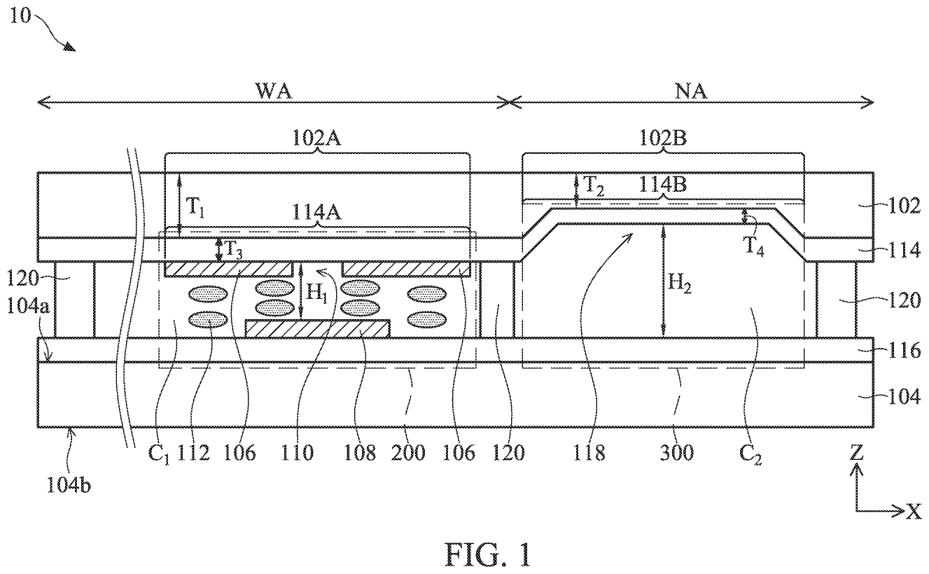

Refer to FIG. 1, which is a cross-sectional diagram of an electronic modulating device 10 in accordance with some embodiments of the present disclosure. It should be understood that additional features may be added to the electronic modulating device 10 in accordance with some embodiments of the present disclosure. Some of the features of the electronic modulating device 10 described below may be replaced or omitted in accordance with some other embodiments of the present disclosure.

As shown in FIG. 1, the electronic modulating device 10 may include a first substrate 102, a second substrate 104, at least one working unit 200, and at least one adjustment structure 300. The second substrate 104 is disposed opposite to the first substrate 102. In addition, the electronic modulating device 10 may include a working region WA and a non-working region NA. The working region WA may be adjacent to the non-working region NA. The first substrate 102 and the second substrate 104 respectively have regions corresponding to the working region WA and the non-working region NA.

In some embodiments, the material of the first substrate 102 and the second substrate 104 may include, but is not limited to, glass, polyimide (PI), any other suitable substrate material, or a combination thereof. In some embodiments, the first substrate 102 and the second substrate 104 may be a flexible substrate, a rigid substrate, or a combination thereof. In some embodiments, the material of the first substrate 102 may be the same as or different from the material of the second substrate 104.

Moreover, the working unit 200 may be disposed between the first substrate 102 and the second substrate 104. In some embodiments, the working unit 200 may be located in the working region WA of the electronic modulating device 10. The working unit 200 may include a first electrode 106 and a second electrode 108. The first electrode 106 and the second electrode 108 may be disposed between the first substrate 102 and the second substrate 104. As shown in FIG. 1, in accordance with some embodiments, the first electrode 106 may include an opening 110 and the opening 110 may overlap the second electrode 108. The second electrode 108 may overlap the first electrode 106. The term “overlap” may refer to partially overlapping or entirely overlapping in the normal direction of the first substrate 102 or the second substrate 104 in the present disclosure. Specifically, the first electrode 106 may be patterned to have the opening 110 in accordance with some embodiments. In some other embodiments, the second electrode 108 may be a patterned electrode divided into several regions (only a portion of the second electrode 108 is illustrated). In addition, the several regions of the second electrode 108 may be connected to different circuits.

In addition, the second electrode 108 may be electrically connected to a functional circuit (not illustrated). The functional circuit may include an active element (e.g., a thin-film transistor (TFT) and/or a chip) or a passive element. In some embodiments, the functional circuit may be located on a surface 104a of the second substrate 104, which is the same as the second electrode 108, and the surface 104a may be adjacent to the first substrate 102. In some other embodiments, the functional circuit may be located on a surface 104b of the second substrate 104, and the second electrode 108 may be electrically connected to the functional circuit through a via hole (not illustrated) that penetrates through the second substrate 104. In still some other embodiments, the functional circuit may be located in the non-working region NA, but it is not limited thereto.

The first electrode 106 and the second electrode 108 may include conductive materials. In some embodiments, the material of the first electrode 106 and the second electrode 108 each may include, but is not limited to, copper, silver, tin, aluminum, molybdenum, tungsten, gold, chromium, nickel, platinum, copper alloy, silver alloy, tin alloy, aluminum alloy, molybdenum alloy, tungsten alloy, gold alloy, chromium alloy, nickel alloy, platinum alloy, another suitable conductive material or a combination thereof.

The first electrode 106 and the second electrode 108 may be formed by using one or more deposition processes, photolithography processes and etching process. In some embodiments, the deposition process may include, but is not limited to, a chemical vapor deposition process, a physical vapor deposition process, an electroplating process, an electroless plating process, another suitable process, or a combination thereof. The physical vapor deposition process may include, but is not limited to, a sputtering process, an evaporation process, or a pulsed laser deposition. In addition, in some embodiments, the photolithography process may include photoresist coating (e.g., spin coating), soft baking, hard baking, mask aligning, exposure, post-exposure baking, developing the photoresist, rinsing, drying, and other suitable processes. In some embodiments, the etching process may include a dry etching process, a wet etching process, or another suitable etching process.

In addition, at least a part of the modulating material 112 may be disposed within the working unit 200. The modulating material 112 is a material that can be adjusted to possess different properties (e.g., dielectric coefficients) by applying an electric field or other methods. In some embodiments, the modulating material 112 includes liquid-crystal molecules, but it is not limited thereto.

Specifically, in some embodiments, the functional circuit may apply a voltage to the second electrode 108, and the properties of the modulation material 112 (e.g., liquid-crystal molecules) between the second electrode 108 and the first electrode 106 may be altered by the change of electric field between the first electrode 106 and the second electrode 108. On the other hand, the functional circuit may also apply another voltage to the first electrode 106, but it is not limited thereto. For example, the voltage may be applied to the first electrode 106 by other circuits. The transmitting direction of the electromagnetic signal that is passed through the opening 110 may then be adjusted by the modulating material 112. Moreover, the first electrode 106 may be electrically floated, grounded, or connected to other functional circuits (not illustrated), but it is not limited thereto. In some embodiments, the electronic modulating device 10 may include an electromagnetic element (not illustrated) for transmitting or receiving electromagnetic signals.

However, it should be understood that one with ordinary skill in the art may adjust the number, the shape in the top view perspective or the arrangement of the first electrode 106, the second electrode 108 and the corresponding opening 110 depending on needs, and it is not limited to the aspect as shown in FIG. 1.

In addition, as shown in FIG. 1, the working unit 200 may have a first cell gap H₁. More specifically, the first cell gap H₁ is defined as the maximum distance of a cavity C₁ in the region of the working unit 200 in the normal direction of the first substrate 102 or the second substrate 104 (e.g., the Z direction as shown in the figure). For example, the maximum distance may be measured after the modulating material 112 is removed, or measured by using an optical instrument. In one embodiment, as shown in FIG. 1, the first cell gap H₁ may be defined as the maximum distance between a first layer 114 and the second electrode 108 in the normal direction of the first substrate 102 or the second substrate 104. In some embodiments, the first cell gap H₁ may correspond to the position where the opening 110 is located. Moreover, in some other embodiments, the first cell gap H₁ may be defined as the maximum distance between the first electrode 106 and a second layer 116 in the normal direction of the first substrate 102 or the second substrate 104.

Furthermore, the electronic modulating device 10 may include an adjustment structure 300. The adjustment structure 300 may be disposed between the first substrate 102 and the second substrate 104. In some embodiments, the adjustment structure 300 may be adjacent to the working unit 200. In some embodiments, the adjustment structure 300 is connected to the working unit 200. The distance between the first substrate 102 and the second substrate 104 that overlaps the adjustment structure 300 may be greater than the distance between the first substrate 102 and the second substrate 104 that overlaps the working unit 200.

As shown in FIG. 1, the adjustment structure 300 may have a second cell gap H₂. More specifically, the second cell gap H₂ is defined as the maximum distance of a cavity C₂ in the region of the adjustment structure 300 in the normal direction of the first substrate 102 or the second substrate 104 (e.g., the Z direction as shown in the figure). For example, the maximum distance may be measured after the modulating material 112 is removed, or measured by using an optical instrument. In one embodiment, as shown in FIG. 1, the second cell gap H₂ may be defined as the maximum distance between the first layer 114 and the second layer 116 in the normal direction of the first substrate 102 or the second substrate 104.

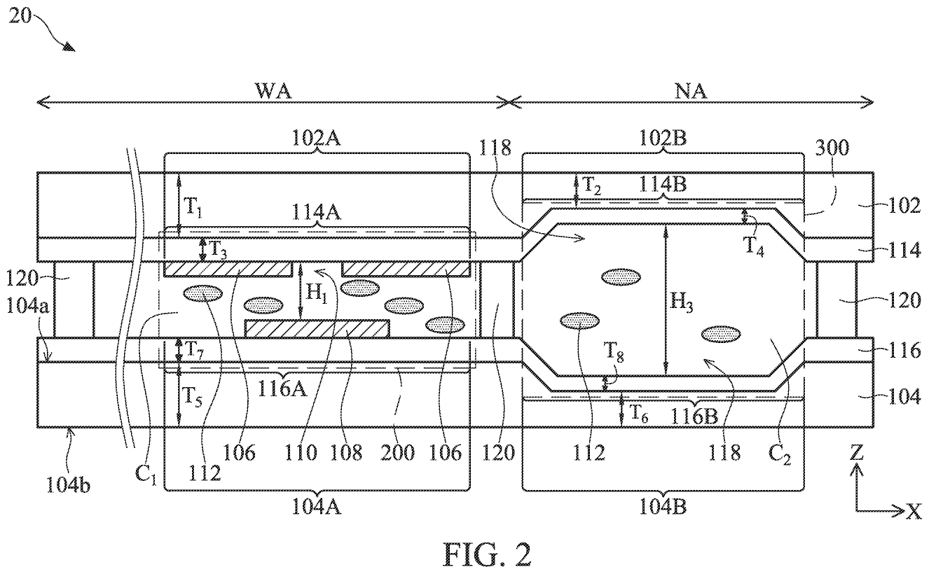

Moreover, as shown in FIG. 1, the second cell gap H₂ of the adjustment structure 300 may be greater than the first cell gap H₁ of the working unit 200. In one embodiment, in a state in which the modulating material 112 is not entirely filled with the electronic modulating device 10, the adjustment structure 300 may adjust the modulating material 112 in the working unit 200 when the operating temperature of the electronic modulating device 10 is changed. Specifically, when the operating temperature of the electronic modulating device 10 is increased, the volume of the modulating material 112 may be increased (for example, the space between molecules and/or atoms is increased). The adjustment structure 300 may accommodate the modulating material 112 that overflows from the working unit 200 (e.g., as shown in FIG. 2) and may reduce the change of first cell gap H₁. Therefore, the quality of the electromagnetic signal that is transmitted or received by the electronic modulating device 10 may be maintained. Moreover, when the operating temperature of the electronic modulating device 10 is decreased, although the volume of the modulating material 112 may be reduced, the modulating material 112 is more likely to gather toward the working unit 200 which has a smaller cell gap (e.g., the first cell gap H₁) due to the capillary phenomenon. In this way, even if the amount of the modulating material 112 is reduced, the working unit 200 may still include sufficient modulating materials to operate normally.

In addition, with such a configuration (i.e. the second cell gap H₂ of the adjustment structure 300 is greater than the first cell gap H₁ of the working unit 200), the modulating material 112 may not need to be entirely filled between the first substrate 102 and the second substrate 104. Therefore, the usage amount of the modulating material 112 may be saved. In some embodiments, the working unit 200 may be filled with the modulating material 112, and the adjustment structure 300 may not include the modulating material 112 or merely include a small amount of the modulating material 112.

In some embodiments, a ratio of the second cell gap H₂ to the first cell gap H₁ may be in a range from about 1.1 to about 100, such as 1.3, 1.5, 5, 7, 10, 20, 35, or 50, but it is not limited thereto. It should be noted that the ratio of the second cell gap H₂ to the first cell gap H₁ should not be too small, otherwise the modulating material 112 may not be easily gather toward the working unit 200. On the other hand, the ratio of the second cell gap H₂ to the first cell gap

H₁ should not be too large, otherwise the modulating material 112 may be separated into several discontinuous portions and affect the function of the electronic modulating device 10.

In some embodiments, portions of the first substrate 102 or the second substrate 104 may be removed by using a patterning process to form the adjustment structure 300. For example, a recess (e.g., the recess 118) may be formed on the first substrate 102 or the second substrate 104 by a patterning process. The recess 118 may increase the cell gap between the first substrate 102 and the second substrate 104, and thus the adjustment structure 300 may be formed. In some embodiments, the patterning process may include a photolithography process and an etching process. The photolithography process may include photoresist coating (e.g., spin coating), soft baking, hard baking, mask aligning, exposure, post-exposure baking, developing the photoresist, rinsing, drying, and other suitable processes. In some embodiments, the etching process may include a dry etching process or a wet etching process.

As shown in FIG. 1, the first substrate 102 may have a first portion 102A that overlaps the working unit 200, and a second portion 102B that overlaps the adjustment structure 300. The second portion 102B of the first substrate 102 may substantially correspond to the position of the recess 118. In some embodiments, a thickness T₁ of the first portion 102A of the first substrate 102 may be greater than a thickness T₂ of the second portion 102B of the first substrate 102. In some embodiments, a ratio of the thickness T₁ of the first portion 102A to the thickness T₂ of the second portion 102B may be in a range from about 1.0 to about 10.0, such as 1.5, 3, 5, or 7, but it is not limited thereto. The thickness T₁ of the first portion 102A and the thickness T₂ of the second portion 102B may be defined as a single measurement of the thickness of the central regions thereof.

As described above, the electronic modulating device 10 may further include the first layer 114 disposed on the first substrate 102 in accordance with some embodiments. The first layer 114 may be disposed between the first substrate 102 and the second substrate 104. In some embodiments, portions of the first layer 114 may be removed (e.g., portions of the first layer 114 may be thinned) by using a patterning process to form the adjustment structure 300. In some embodiments, the working unit 200 may include a first portion 114A of the first layer 114, and the adjustment structure 300 may include a second portion 114B of the first layer 114. The second portion 114B of the first layer 114 may correspond to the position of the recess 118. In some embodiments, a thickness T₃ of the first portion 114A of the first layer 114 may be greater than or equal to a thickness T₄ of the second portion 114B of the first layer 114. In some embodiments, a ratio of the thickness T₃ of the first portion 114A to the thickness T₄ of the second portion 114B may be in a range from about 1.0 to about 50, such as 10 or 20, but it is not limited thereto. In some other embodiments, at least one of the thickness T₃ of the first portion 114A and the thickness T₄ of the second portion 114B may be zero (i.e. portions of the first substrate 102 may be exposed). The thickness T₃ of the first portion 114A and the thickness T₄ of the second portion 114B may be defined as a single measurement of the thickness of the central regions thereof.

In some embodiments, the first layer 114 may include a metal layer (e.g., a circuit layout layer), an insulating layer, other functional structures of the electronic modulating device, or a combination thereof. In some embodiments, the material of the first layer 114 may include metal material, insulating material, or a combination thereof. For example, the metal material may include, but is not limited to, copper, aluminum, molybdenum, tungsten, gold, chromium, nickel, platinum, silver, tin, copper alloy, aluminum alloy, molybdenum alloy, tungsten alloy, gold alloy, chromium alloy, nickel alloy, platinum alloy, silver alloy, tin alloy, another suitable conductive material or a combination thereof. For example, the insulating material may include an organic material, an inorganic material, another suitable insulating material, or a combination thereof. The organic material may include, but is not limited to, an acrylic or methacrylic organic compound, an isoprene compound, phenol-formaldehyde resin, benzocyclobutene (BCB), perfluorocyclobutane (PECB), polyimide, polyethylene terephthalate (PET), or a combination thereof. The inorganic material may include, but is not limited to, silicon nitride, silicon oxide, or silicon oxynitride or a combination thereof.

In addition, the electronic modulating device 10 may further include the second layer 116 disposed on the second substrate 104 in accordance with some embodiments. The second layer 116 may include a metal layer (e.g., a circuit layout layer), an insulating layer, other functional structures of the electronic modulating device, or a combination thereof. In some embodiments, the material of the second layer 116 may include metal material, insulating material, or a combination thereof. The metal material and the insulating material are similar to those of the first layer 114, and thus will not be repeated herein. In some embodiments, the material forming the second layer 116 may be the same as or different from the material of the first layer 114.

Moreover, it should be understood that although the first layer 114 and the second layer 116 in the embodiment shown in FIG. 1 are both single-layered structures, the first layer 114 and/or the second layer 116 may have a multi-layered structure in accordance with some other embodiments. In addition, it should be understood that only one working unit 200 and one adjustment structure 300 are illustrated in FIG. 1 to simplify the figure, and the electronic modulating device 10 may actually include several working units 200 and several adjustment structures 300.

In addition, the electronic modulating device 10 may further include spacer elements 120. The spacer elements 120 may be disposed between the first substrate 102 and the second substrate 104. The spacer elements 120 may be disposed in the working region WA and the non-working region NA. In some embodiments, the spacer elements 120 may be disposed between the working units 200. In some embodiments, the modulating material 112 may be disposed adjacent to the spacer elements 120. The spacer element 120 may be used to reinforce the structural strength of the electronic modulating device 10. In some embodiments, the spacer element 120 may extend along a direction that is substantially perpendicular to the first substrate 102 or the second substrate 104. In addition, in some embodiments, the spacer elements 120 may have a ring shape. In some other embodiments, the spacer elements 120 have columnar structures and are arranged in parallel.

Moreover, the material of the spacer element 120 may include an insulating material, a conductive material, or a combination thereof. In some embodiments, the conductive material may include, but is not limited to, copper, silver, gold, copper alloy, silver alloy, gold alloy, or a combination thereof. In some other embodiments, the insulating material may include, but is not limited to, polyethylene terephthalate (PET), polyethylene (PE), polyethersulfone (PES), polycarbonate (PC), polymethylmethacrylate (PMMA), glass, or a combination thereof. In addition, the spacer element 120 may have adhesion properties.

Next, refer to FIG. 2, which is a cross-sectional diagram of an electronic modulating device 20 in accordance with some embodiments of the present disclosure. It should be understood that the same or similar components or elements in above and below contexts are represented by the same or similar reference numerals. The materials, manufacturing methods and functions of these components or elements are the same or similar to those described above, and thus will not be repeated herein. The electronic modulating device 20 shown in FIG. 2 is similar to the electronic modulating device 10 shown in FIG. 1. The difference between them is that except the first substrate 102 and the first layer 114 are patterned, the second substrate 104 and the second layer 116 are also patterned to form the adjustment structure 300 in the electronic modulation device 20.

Specifically, portions of the second substrate 104 and the second layer 116 may be removed (e.g., portions of the second substrate 104 and the second layer 116 may be thinned) by using the photolithography process and the etching process as described above to form the recesses 118. The recesses 118 may increase the cell gap between the first substrate 102 and the second substrate 104, and thus the adjustment structure 300 may be formed. In some embodiments, only portions of the first layer 114 and/or the second layer 116 may be removed, without removing portions of the first substrate 102 and/or the second substrate 104.

As shown in FIG. 2, in the electronic modulating device 20, the adjustment structure 300 may have a third cell gap H₃, and the third cell gap H₃ may be located between the first layer 114 and the second layer 116. In some embodiments, if at least one of the first layer 114 and the second layer 116 includes a hollowed-out portion, the third cell gap H₃ may be located between the first substrate 102 and the second substrate 104. The third cell gap H₃ of the adjustment structure 300 may be greater than the first cell gap H₁ of the working unit 200. The adjustment structure 300 may be used to maintain the first cell gap H₁ of the working unit 200. In some embodiments, a ratio of the third cell gap H₃ to the first cell gap H₁ may be in a range from about 1.1 to about 110, such as 1.5, 5, 7, 10, 20, 35, or 50, but it is not limited thereto. In some embodiments, a ratio of the third cell gap H₃ to the second cell gap H₂ may be in a range from about 0.95 to about 1.5, such as 1.1 or 1.3.

Specifically, the second substrate 104 also may have a first portion 104A that overlaps the working unit 200, and a second portion 104B that overlaps the adjustment structure 300. The second portion 104B of the second substrate 104 may substantially correspond to the position of the recess 118. In some embodiments, a thickness T₅ of the first portion 104A of the second substrate 104 may be greater than a thickness T₆ of the second portion 104B of the second substrate 104. In some embodiments, a ratio of the thickness T₅ of the first portion 104A to the thickness T₆ of the second portion 104B may be in a range from about 1.0 to about 10, such as 1.5, 3, 5, or 7, but it is not limited thereto. The thickness T₅ of the first portion 104A and the thickness T₆ of the second portion 104B may be defined as a single measurement of the thickness of the central regions thereof.

Furthermore, the working unit 200 may include a first portion 116A of the second layer 116, and the adjustment structure 300 may include a second portion 116B of the second layer 116. The second portion 116B of the second layer 116 may also substantially correspond to the position of the recess 118. In some embodiments, a thickness T₇ of the first portion 116A of the second layer 116 may be greater than a thickness T₅ of the second portion 116B of the second layer 116. In some embodiments, a ratio of the thickness T₇ of the first portion 116A to the thickness T₅ of the second portion 116B may be in a range from about 1.0 to about 50, such as 10 or 20, but it is not limited thereto. In some other embodiments, at least one of the thickness T₇ of the first portion 116A and the thickness T₅ of the second portion 116B may be zero (i.e. portions of the second substrate 104 may be exposed). The thickness T₇ of the first portion 116A and the thickness T₅ of the second portion 116B may be defined as a single measurement thickness of the central regions thereof.

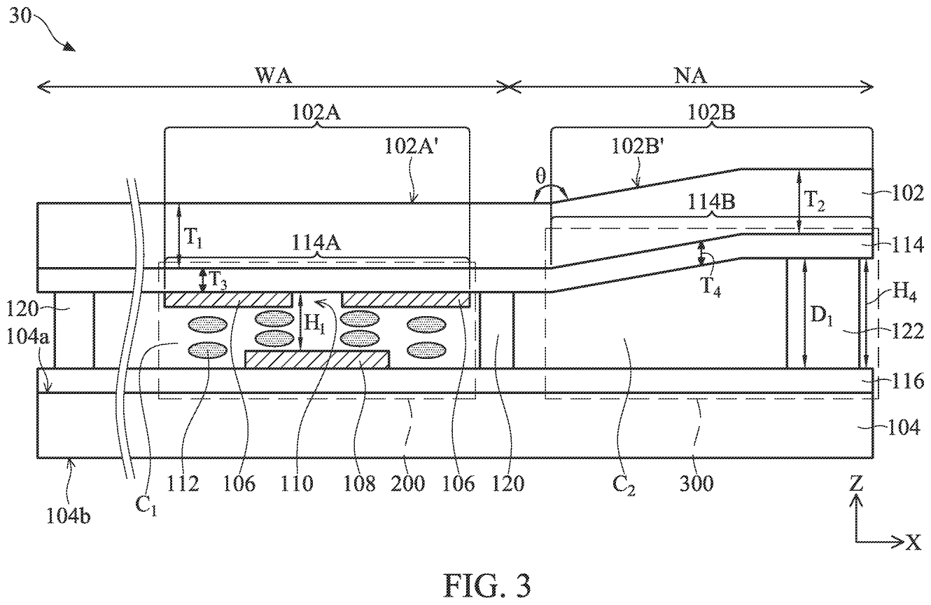

Next, refer to FIG. 3, which is a cross-sectional diagram of an electronic modulating device 30 in accordance with some embodiments of the present disclosure. As shown in FIG. 3, the electronic modulating device 30 may also include the working unit 200 and the adjustment structure 300 disposed between the first substrate 102 and the second substrate 104. In this embodiment, the adjustment structure 300 may include a fourth cell gap H₄ that is greater than the first cell gap H₁ of the working unit 200. In some embodiments, a ratio of the fourth cell gap H₄ to the first cell gap H₁ may be in a range from about 1.1 to about 100, such as 1.3, 1.5, 5, 7, 10, 20, 35, or 50, but it is not limited thereto. The cell gap (for example, the fourth cell gap H₄) may be measured according to the measurement method similar to that as described above, and will not be repeated herein.

In particular, in this embodiment, the adjustment structure 300 may include a supporting member 122 disposed between the first substrate 102 and the second substrate 104 so that the fourth cell gap H₄ of the adjustment structure 300 may be greater than the first cell gap H₁.

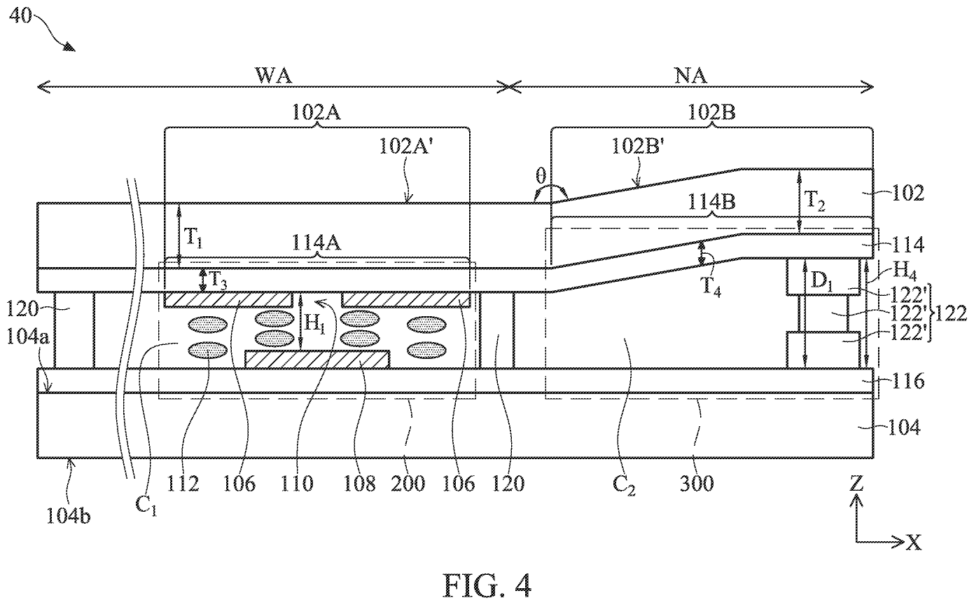

Moreover, the supporting member 122 may have a height D₁. In some embodiments, the height D₁ of the supporting member 122 may be substantially the same as the fourth cell gap H₄. For example, a ratio of the height D₁ of the supporting member 122 to the fourth cell gap H₄ may be in a range from about 0.9 to about 1.1. In some other embodiments, the fourth cell gap H₄ may be greater than the height D₁ of the supporting member 122. In addition, in some embodiments, since the first substrate 102 may be raised by the stretching of the supporting member 122, the first portion 102A of the first substrate 102 that overlaps the working unit 200 may be flat and the second portion 102B of the first substrate 102 that overlaps the adjustment structure 300 may be bent from a side view perspective (e.g., in an X-Z plane shown in FIG. 4). In some embodiments, there may be an included angle 0 between a top surface 102A′ of the first portion 102A of the first substrate 102 and a top surface 102B′ of the second portion 102B of the first substrate 102. The top surface 102B′ may be adjacent to the top surface 102A′. In some embodiments, the included angle θ may be in a range from about 135 degrees to about 180 degrees, such as 150 degrees, 160 degrees, 170 degrees, or 175 degrees, but it is not limited thereto.

In some embodiments, the material of the supporting member 122 may include, but is not limited to, dielectric material, metal material, organic material, or a combination thereof. In some embodiments, the dielectric material may include, but is not limited to, silicon oxide, silicon nitride, silicon oxynitride, another high-k dielectric material, or a combination thereof. In some embodiments, the metal material may include, but is not limited to, copper, silver, gold, copper alloy, silver alloy, gold alloy, another suitable metal material, or a combination thereof. In some embodiments, the organic material may include, but is not limited to, polyimide (PI), epoxy resin, acrylic resin (e.g., polymethylmetacrylate (PMMA)), benzocyclobutene (BCB), polyester, polydimethylsiloxane (PDMS), polytetrafluoroethylene (PFA) or a combination thereof.

In addition, in some embodiments, the supporting member 122 may include, but is not limited to, a sealant, a photo spacer, a liquid crystal polymer (LCP) layer, or a combination thereof. In some embodiments, the supporting member 122 may include a photo-curing or thermal curing sealant. For example, the supporting member 122 may include a photo-curing sealant (UV light or visible light), a thermal curing sealant, or a photothermal curing sealant.

Next, refer to FIG. 4, which is a cross-sectional diagram of an electronic modulating device 40 in accordance with some embodiments of the present disclosure. The electronic modulating device 40 shown in FIG. 3 is similar to the electronic modulating device 30 shown in FIG. 3. The difference between them is that the supporting member 122 may include a plurality of supporting units 122′ in the electronic modulation device 40. In this embodiment, the supporting member 122 may include a stacked structure including several supporting units 122′. In some embodiments, the several supporting units 122′ may include the same or different materials. In some embodiments, the several supporting units 122′ may have the same or different widths or shapes. In some embodiments, a part of the supporting units 122′ may include the same material while a part of the supporting units 122′ may include different materials. The height D₁ may be defined as the maximum height of the supporting member 122 in the normal direction of the first substrate 102 or the second substrate 104 (e.g., the Z direction as shown in the figure).

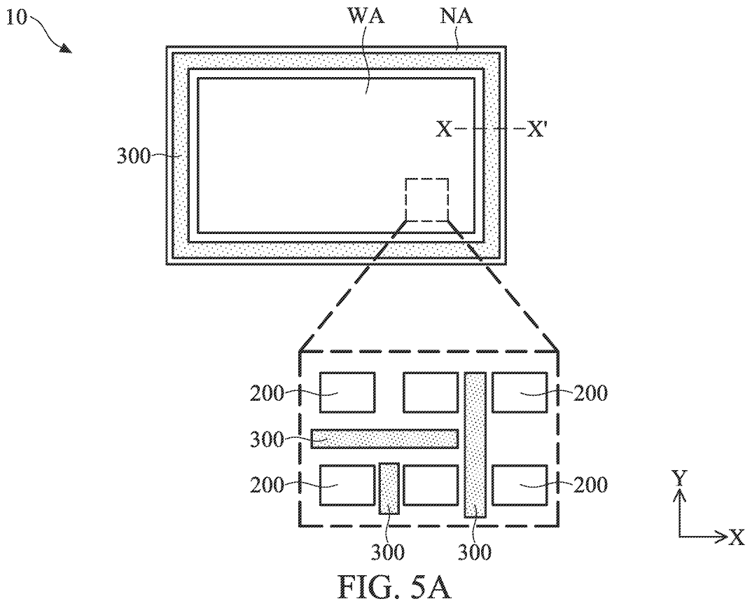

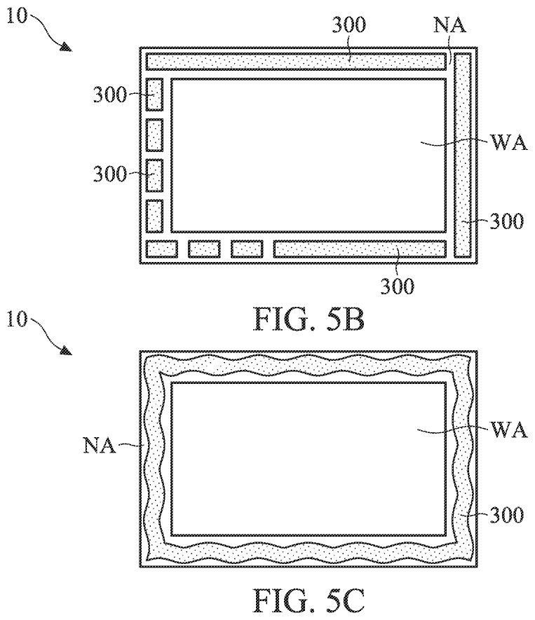

Next, refer to FIG. 5A, which is a top-view diagram of the electronic modulating device 10 in accordance with some embodiments of the present disclosure. The line segment X-X′ shown in FIG. 5A may correspond to the cross-sectional diagram shown in FIG. 1. As shown in FIG. 5A, in some embodiments, the non-working region NA may be disposed adjacent to the working region WA. The adjustment structure 300 may be disposed in the non-working region NA, and the working unit 200 may be disposed in the working region WA. As described above, the modulating material 112 is more likely to gather in the working unit 200 that has a smaller cell gap. In this way, even if the temperature changed, the working unit 200 may still include sufficient modulating materials 112 so that the electronic modulating device 10 may carry out normal function.

Furthermore, in some embodiments, the adjustment structure 300 may also be disposed in the working region WA. Specifically, in some embodiments, the adjustment structure 300 may be disposed between portions of the working unit 200. In addition, the adjustment structure 300 may be appropriately disposed between the working units 200 depending on needs.

Next, referring to FIG. 5B and FIG. 5C, which are top-view diagrams of the electronic modulating device 10 in accordance with some other embodiments of the present disclosure. As shown in FIG. 5B, in some embodiments, the adjustment structure 300 may be discontinuously disposed in the non-working region NA. As shown in FIG. 5C, in some embodiments, the adjustment structure 300 may be continuously disposed in the non-working region NA of the electronic modulating device. Similarly, the adjustment structures 300 that are disposed in the working region WA may be arranged in the manner as described above. In some embodiments, the adjustment structure 300 may extend from the non-working region NA to the working region WA. Moreover, as shown in FIG. 5C, in some embodiments, the adjustment structure 300 may have a curved shape, a bent shape, or any other suitable shape in a top view perspective.

To summarize the above, in accordance with some embodiments of the present disclosure, the electronic modulating device may adjust the modulating material located in the working unit by the adjustment structure when the temperature is changed. Therefore, the working unit may be maintained in a state of having sufficient modulating material. When the operating temperature of the electronic modulating device is increased, the adjustment structure may accommodate the modulating material that that overflows from the working unit due to the increase in volume. On the contrary, when the operating temperature of the electronic modulating device is decreased, the modulating material may be more likely to gather toward the working unit which has a smaller cell gap due to the capillary phenomenon. In accordance with some embodiments, the cell gap of the working region may be unaffected by temperature, and thus the electronic modulating device may still maintain stable performance when the temperature is changed.

Although some embodiments of the present disclosure and their advantages have been described in detail, it should be understood that various changes, substitutions and alterations can be made herein without departing from the spirit and scope of the disclosure as defined by the appended claims. For example, it will be readily understood by one of ordinary skill in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An electronic modulating device, comprising:
a first substrate;
a second substrate disposed opposite to the first substrate;
at least one working unit comprising a first cell gap and disposed between the first substrate and the second substrate, wherein the at least one working unit comprises a modulating material; and
at least one adjustment structure comprising a second cell gap and disposed between the first substrate and the second substrate, wherein the second cell gap is greater than the first cell gap.

2. The electronic modulating device as claimed in claim 1, wherein a ratio of the second cell gap to the first cell gap is in a range from 1 to 100.

3. The electronic modulating device as claimed in claim 1, wherein a first portion of the first substrate overlaps the at least one working unit, wherein a second portion of the first substrate overlaps the at least one adjustment structure, and a thickness of the first portion of the first substrate is greater than a thickness of the second portion of the first substrate.

4. The electronic modulating device as claimed in claim 3, wherein a ratio of the thickness of the first portion of the first substrate to the thickness of the second portion of the first substrate is greater than 1 and less than or equal to 10.

5. The electronic modulating device as claimed in claim 1, further comprising a first layer disposed between the first substrate and the second substrate, wherein the first layer comprises a first portion and a second portion, and the first portion overlaps the at least one working unit, the second portion overlaps the at least one adjustment structure, and a thickness of the first portion of the first layer is greater than or equal to a thickness of the second portion of the first layer.

6. The electronic modulating device as claimed in claim 1, comprising a working region and a non-working region, wherein the at least one working unit is located in the working region.

7. The electronic modulating device as claimed in claim 6, wherein the at least one adjustment structure is located in the working region.

8. The electronic modulating device as claimed in claim 6, wherein the at least one adjustment structure is located in the non-working region.

9. The electronic modulating device as claimed in claim 3, wherein the first substrate comprises a recess, and the recess corresponds to the second portion of the first substrate.

10. The electronic modulating device as claimed in claim 9, wherein the recess comprises an obtuse angle.

11. The electronic modulating device as claimed in claim 9, further comprising a first layer disposed on the first substrate and in the recess, wherein a thickness of the first layer disposed in the recess is smaller than a thickness of other portion of the first layer.

12. The electronic modulating device as claimed in claim 3, wherein a first portion of the second substrate overlaps the at least one working unit, wherein a second portion of the second substrate overlaps the at least one adjustment structure, and a thickness of the first portion of the second substrate is greater than a thickness of the second portion of the second substrate.

13. The electronic modulating device as claimed in claim 12, wherein the second substrate comprises a recess, and the recess corresponds to the second portion of the second substrate.

14. The electronic modulating device as claimed in claim 12, wherein a ratio of the thickness of the first portion of the second substrate to the thickness of the second portion of the second substrate is greater than 1 and less than or equal to 10.

15. The electronic modulating device as claimed in claim 5, wherein a material of the first layer comprises metal material, insulating material, or a combination thereof.

16. The electronic modulating device as claimed in claim 1, wherein the working unit comprises a first electrode and a second electrode disposed between the first substrate and the second substrate, wherein the first electrode comprises an opening overlapping the second electrode.

17. The electronic modulating device as claimed in claim 1, further comprising a spacer element disposed between the first substrate and the second substrate.

18. The electronic modulating device as claimed in claim 8, wherein the adjustment structure is discontinuously disposed in the non-working region.

19. The electronic modulating device as claimed in claim 8, wherein the adjustment structure is continuously disposed in the non-working region.

20. The electronic modulating device as claimed in claim 1, which is used for transmitting or receiving electromagnetic signals.
